(19) United States
(12) Patent Application Publication
(10) Pub. No.: US 2004/0131006 A1
(43) Pub. Date: Jul. 8, 2004

(54) Multi-layered optical disk and optical disk recording/reproducing apparatus

(76) Inventor: Hiroshi Hasegawa, Yokosuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/668,209

(22) Filed: Sep. 24, 2003

(30) Foreign Application Priority Data
Sep. 30, 2002 (JP) 2002-288016

(51) Int. Cl. G11B 7/24

(52) U.S. Cl. 369/275.3; 430/945; 369/286; 428/64.4

(57) ABSTRACT

A multi-layered optical disk is provided with first and second rewritable recording layers. One of the layers has a read-in emboss-area in which a pit array is formed, and the both of the layer have groove areas other than the emboss-area, on which grooves are formed. The other recording layer has a non-recording region on the groove area, on which data is prevented from recording. The groove areas on the layers excluding the non-recording region are defined as recordable regions on which user can record data. The non-recording region is so located as to oppose to the read-in emboss-area.

### CROSS-REFERENCE TO RELATED APPLICATIONS

This application is based upon and claims the benefit of priority from the prior Japanese Patent Application No. 2002-288016, filed September 30, the entire contents of which are incorporated herein by reference.

### BACKGROUND OF THE INVENTION

1. Field of the Invention

The present invention relates to a multi-layered optical disk and an optical disk recording/reproducing apparatus.

2. Description of the Related Art

Optical disks are of various types such as a read-only memory (ROM) type, write-only non-erasable write-once type, and data erasable/rewritable type (i.e., RAM type). A DVD disk in which information is recorded at a higher density as compared with CD has been developed as the optical disk. Furthermore, to record more data, a disk including two recording layers has been developed.

As the DVD disk which is of the read only type and which includes a double-layer structure, for example, as described in Jpn. Pat. Appln. KOKAI Publication No. 8-255347, there is a disk in which a first recording layer is disposed at the side of an incident surface faced to an objective lens and a second layer is disposed between the first recording layer and a back surface. In this disk, a read-in area is defined on an inner peripheral side of the first recording layer, and a read-out area is defined on an outer peripheral side of the layer. The read-in area is defined on the outer peripheral side of the second layer, and the read-in area is defined on the inner peripheral side of the layer. The read-in area of the first recording layer, the read-out area of the first recording layer, the read-out area of the second layer, and the read-in area of the second layer are continuously searched in this order so that continuous data can be read. Since this DVD disk including the double-layer structure is of the read-only type, a continuous pit array is formed both in the first and second recording layers. When the pit array is traced with a laser beam, the laser beam is modulated and the data is read out from the pit array.

Moreover, examples of a rewritable disk include a DVD-RAM which is rewritable in a phase change system, but the rewritable disk which has heretofore been known includes a single-layer structure, and a rewritable disk including the double-layer structure has not been developed. In the DVD-RAM including the single-layer structure, so-called guide grooves, that is, tracking guides are formed in a large part of area. A user can arbitrarily record information as a phase change mark array in the guide grooves or in lands between the guide grooves. In this type of disk, not the guide grooves but the pit array referred to as a read-in emboss is disposed in the innermost peripheral read-in area. For a purpose of providing information of attribute and use condition of the optical disk before the user records the arbitrary information in this disk, this pit array is recorded as concave/convex portions of the surface at the time of molding of a disk substrate.

As described above, a rewritable multi-layered optical disk including recording layers disposed at predetermined intervals has not heretofore been developed. In the development of such rewritable optical disk, simply in the same manner as in a ROM disk, it is assumed that the read-in emboss or read-out emboss is disposed in the read-in area in one or both of two layers. However, in the disk having the rewritable multi-layered structure, when a boundary between the read-in emboss and groove area of a certain layer is searched, noise is generated, and there is possibility that reliability of information recording/reproducing drops.

### BRIEF SUMMARY OF THE INVENTION

An object of the present invention is to provide a rewritable multi-layered optical disk which can improve reliability of information recording/reproducing, and an optical disk recording/reproducing apparatus for the rewritable multi-layered optical disk.

According to an aspect of the invention, there is provide a multi-layered optical disk to which information can be recorded with a focused light beam, comprising:

a transparent substrate;

first and second recording layers faced to each other and supported by the transparent substrate, the first recording layer having a non-erasable information zone on which a pit array is formed as non-erasable information and a first recordable zone on which a recording mark array is formed with an irradiation of the focused light beam passing through the transparent substrate, the second recording layer having a non-recording zone on which data is prevented from being recoded and a second recordable zone on which a recording mark array is formed with the irradiation of the focused light beam, and the non-recording zone being faced to the non-erasable information zone and including an illumination region on which a beam spot is formed by the light beam focused on the non-erasable information zone.

According to an another aspect of the invention, there is provide a recording/reproducing apparatus for reproducing information from and recording information on a multi-layered optical disk comprising:

a light beam unit configured to generate a focused light beam on the optical disk, optical disk including

a transparent substrate;

first and second recording layers faced to each other and supported by the transparent substrate, the first recording layer having a non-erasable information zone on which a pit array is formed as non-erasable information and a first recordable zone on which a recording mark array is formed with the irradiation of the focused light beam passing through the transparent substrate, the second recording layer having a non-recording zone on which data is prevented from being recoded and a second recordable zone on which a recording mark array is formed with the irradiation of the focused light beam, the non-recording zone being faced to the non-erasable information zone and including an illumination region on which a beam spot is formed by the light beam focused on the non-erasable information zone, and the non-erasable information zone includes address information for specifying the non-recording zone on the second recording layer; and

control unit configured to control reading of information on the non-erasable information zone and recording of data on the first and second recording layer to prevent data from being recorded on the non-recording zone based on the address information.

### BRIEF DESCRIPTION OF THE SEVERAL VIEWS OF THE DRAWING

FIG. 1 is a broken perspective view schematically showing a structure of a multi-layered optical disk according to a first embodiment of the present invention;

FIG. 2 is a block diagram schematically showing a recording/reproducing apparatus which records/reproduces information with respect to the multi-layered optical disk shown FIG. 1;

FIGS. 3A to 3C are explanatory views showing a function of a light beam in recording or reproducing in the multi-layered optical disk shown in FIG. 1; and

FIG. 4 is a broken perspective view schematically showing a structure of the multi-layered optical disk according to a second embodiment of the present invention.

### DETAILED DESCRIPTION OF THE INVENTION

A multi-layered optical disk and a recording/reproducing apparatus for recording data on and reproducing data from the multi-layered optical disk according to embodiments of the present invention will be described hereinafter with reference to the drawings.

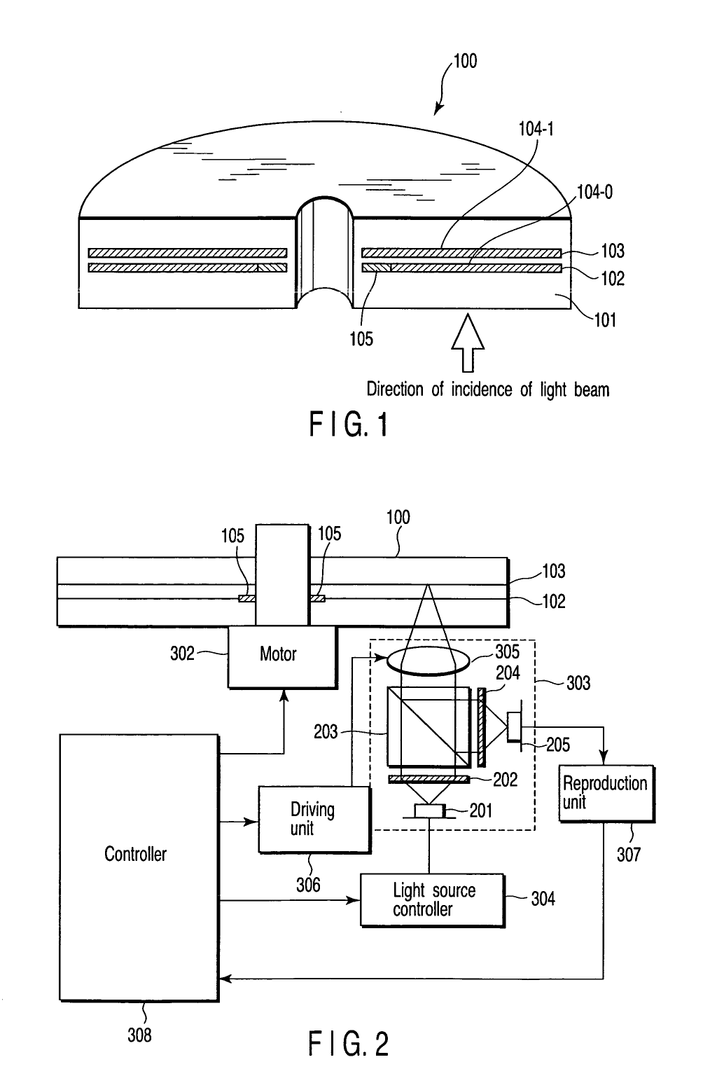

FIG. 1 is a broken perspective view schematically showing the multi-layered optical disk according to one embodiment of the present invention.

An optical disk 100 shown in FIG. 1 is of a rewritable type, and has a multi-layered structure, that is, has two recording layers 102, 103. In the optical disk 100, the 0 recording layer 102 and first recording layer 103 are buried in a transparent optical disk substrate 101 so that the recording layers are disposed opposite to each other at a micro interval. Here, the 0 recording layer 102 is disposed at an incident surface side of the disk 100 and the first recording layer 103 is disposed at the opposite surface side of the disk 100. That is, the 0 recording layer 102 is disposed further in the vicinity of the objective lens as compared with the first recording layer 103, and both of the layers are faced to an incident direction X of a light beam. Thus, the light beam emerged from the objective lens (not shown in FIG. 1) is incident on the incident surface of the disk, passes through the substrate 102, and focused on the 0 recording layer 102 to search the 0 recording layer 102. The first recording layer 103 is disposed between the opposite surface of the disk and the 0 recording layer 102. Thus, the light beam passing through the 0 recording layer 102 is also focused on the first recording layer 103 to search the first recording layer 102.

The 0 recording layer 102 and first recording layer 103 have groove areas 104-0, 104-1 as rewritable data zones extending to an outer periphery from an inner periphery, respectively. Spiral grooves are formed in the groove areas 104-0, 104-1 to guide the light beam. The 0 recording layer 102 and first recording layer 103, especially the groove areas 104-0, 104-1, are formed of recording materials of a phase change type so as to record data. The areas are irradiated with recording light beam having a recording level in a recording mode. In the recording mode, phase change is caused to form marks on the recording materials. When the areas are irradiated with erase light beam having an erase level in an erasing mode, the phase change is similarly caused to erase the marks. The light beam is guided by the groove into a mark array of continuous marks, and data is recorded as the mark array in a bottom surface in the corresponding groove, or in a flat portion of a land between the grooves. To record data at a higher density, the mark array is formed in the bottom surface of the groove and also in the flat portion of the land between the grooves to record information or data. In a reproduction mode, the groove and/or the land are searched with the light beam at a reproduction level, and the reproduction light beam is modulated in intensity.

As shown in FIG. 1, in the innermost peripheral read-in area of the 0 recording layer, a read-in emboss-area 105 is provided, in which information or data of the attribute and use condition of the optical disk, such as physical format information, is recorded as non-erasable information. Different from the groove area, no groove is formed in the read-in emboss-area 105, and a pit array is continuously formed in the area. The groove area is formed as the rewritable data zone adjacent to the read-in emboss-area 105, that is, outside the read-in emboss-area 105.

In the disk shown in FIG. 1, the groove area 104-0 is formed to an outermost periphery from an outer periphery of the read-in emboss-area 105 in the 0 recording layer, and the groove area 104-1 is formed to an innermost peripheral area from the outermost periphery of the first recording layer. On the contrary, the first recording layer 103 has no read-out emboss-area. Thus, the groove area 104-1 is continuously formed from the innermost peripheral area to the outermost periphery in the first recording layer 103. The inner peripheral area having no read-out emboss-area in the first recording layer 103 is faced to the read-in emboss-area 105 of the 0 recording layer 102 as shown in FIG. 1, which is a different from a structure of ROM having double-layers. Since the first recording layer 103 has no read-in emboss-area, even if the inner peripheral area of the first recording layer 103 is defined as the read-out area, the inner peripheral area of the first recording layer 103 has substantially the same physical characteristics as those of the other groove area 104-1.

Moreover, in the groove area 104-1, the groove or grooves are formed in the innermost peripheral area of the first recording layer 103 which corresponds to no read-in emboss-area. However, the innermost peripheral area of the first recording layer 103 is defined as a non-recording zone on which data is prevented from being recorded and no data is recorded. The non-recording zone is also defined as an illumination region on which the light beam focused on the emboss-area 105 and passing through the emboss-area is projected. The groove area 104-1 excluding the non-recording zone is defined in a recording zone of the first recording layer 103, where information or data can substantially be recorded with the light beam passing through the recording zone of the 0 recording layer 102. A boundary between the recordable zone and the non-recording zone on the first recording layer 103 is determined by an outer peripheral edge of a beam spot, when the light beam is focused on a boundary between the recordable zone and the emboss-area of the 0 recording layer 102 and passes the 0 recording layer 102 and forms the beam spot on the first recording layer 103, as described later. That is, the non-recording zone has an outer peripheral edge area in which the beams spot is formed by the light beam which is focused on the boundary between the recordable zone and the emboss-area of the 0 recording layer 102. The non-recording zone and/or the recording zone where data can substantially be recorded in the first recording layer 103 is designated by track address or addresses in the read-in emboss-area 105, and the address is preferably referred to in controlling the reproducing and recording.

FIG. 2 is a block diagram of an optical disk recording/reproducing apparatus. In the apparatus, information or data is recorded in the multi-layered optical disk 100 shown in FIG. 1, the recorded information or data is erased, or information or data is reproduced from the multi-layered optical disk 100. As shown in FIG. 1, the multi-layered optical disk 100 is rotated by a motor 302 at a predetermined speed, and the disk is irradiated with the light beam from an objective lens 305 of an optical head 303. Therefore, the light beam is guided along the pit arrays or the grooves of the 0 recording layer 102 and first recording layer 103 so as to search the read-in emboss-area 105 or the groove areas 104-0, 104-1 of the 0 recording layer 102 and first recording layer 103 with the light beam.

The objective lens 305 is driven in a focus direction by an objective lens driving unit 306, and focuses the light beam on one of the 0 recording layer 102 and first recording layer 103 to be constantly searched. The objective lens 305 is driven in a tracking direction by the objective lens driving unit 306 so as to track the pit array of the read-in emboss-area 105 or the grooves of the groove areas 104-0, 104-1 with the light beam from the objective lens 305. The optical head 303 includes a semiconductor laser 201, and the semiconductor laser generates a light beam for recording or for reproducing toward the light source objective lens 305. The light beam from the objective lens 305 is collimated by a collimator lens 202, and the collimated light beam is incident upon the objective lens 305 via a half prism 203. The light beam converged by the objective lens 305 is incident upon the 0 recording layer 102 and first recording layer 103, reflected by the 0 recording layer 102 and first recording layer 103, returned to the objective lens 305, and passed through the objective lens 305 to return to the half prism 203. A part of the reflected light beam is reflected by the half prism 203, and converged by a projection lens 204 to irradiate a detector 205. The detector 205 generates a detection signal in response to the reflected light beam, and the detection signal is supplied to a reproduction unit 307. In the reproduction unit 307, a reproduction signal is produced from the detection signal, and focus and tracking signals are produced in accordance with focus and tracking states of the objective lens 305. The reproduction signal, focus signal, and tracking signal are supplied to a controller 308. When either a reproduction mode or a recording mode is set, the controller 308 controls a light source controller 304 to generate the light beam in accordance with the reproduction mode and recording mode. The controller 308 controls the objective lens driving unit 306 in response to the focus and tracking signals, and maintains the objective lens 305 in the focus and tracking states. The reproduction signal is supplied to an external circuit if necessary, processed in the external circuit, and reproduced as video or sound.

In the recording/reproducing apparatus shown in FIG. 2, first the reproduction light beam is focused on the 0 recording layer 102 of the optical disk to search the pit array of the read-in emboss-area 105. The information of the attribute or use condition of the optical disk is read out, and supplied to the controller 308. Thereafter, following a user's request, the light beam is controlled and focused in arbitrary portions of the 0 recording layer 102 or the first recording layer 103 to record or reproduce information or data. Here, as described above, the address of the non-recording zone from the emboss-area 105 and/or the area where information or data can substantially be recorded in the first recording layer 103 is read out. In this area, the recording/reproducing of information or data is preferably controlled to be invalid.

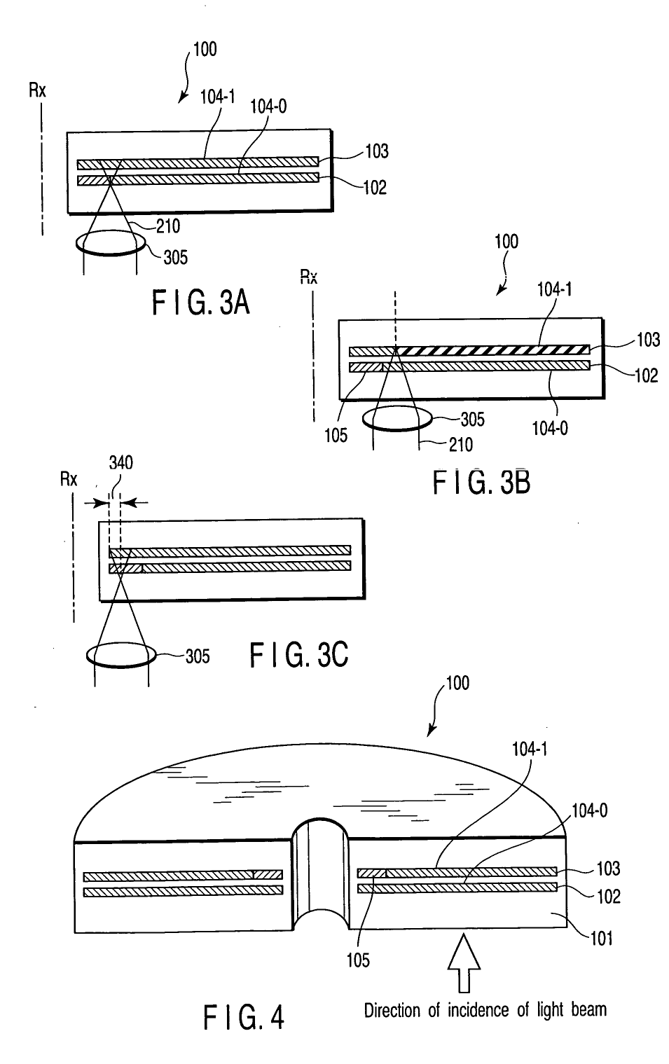

FIG. 3A shows an irradiated area with the light beam in a state in which the 0 recording layer 102 of the optical disk 100 is selected and a light beam 210 is directed to the outer peripheral portion of the read-in emboss-area 105 in the above-described recording/reproducing apparatus. In FIG. 3A, symbol Rx denotes a rotation center of the optical disk 100. The light beam is focused on the 0 recording layer 102 to form a beam spot on the surface of the layer. A part of the light beam 210 is transmitted through the 0 recording layer 102 and incident upon the first recording layer 103. Since the light beam forms the beam spot in the 0 recording layer 102, the beam is diffused and incident upon the first recording layer 103 to form a background pattern relatively largely spreading as compared with the beam spot in the first recording layer 103. The first recording layer 103 in which the background pattern is formed is defined in the groove area 104-1 which has substantially the same physical characteristics. Therefore, the reflected light beam from this background pattern does not produce a luminance pattern which is excessively non-uniform, and the beam is reflected as a relatively uniform luminance pattern which has a distribution corresponding to the incident light beam. Therefore, even when the luminance pattern from the background pattern is mixed as noise into the reflected light beam reflected from the beam spot on the 0 recording layer 102, an influence of the luminance pattern from the background pattern is relatively small on the detector 205, and reliability of the reproduction signal is prevented from dropping.

This is not limited to the state in which the light beam 210 is directed to the outer peripheral portion of the read-in emboss-area 105. Even when any area of the 0 recording layer 102 such as the groove area of the inner peripheral portion of the optical disk 100 is searched with the light beam, the influence of the luminance pattern from the background pattern is relatively small, and the reliability of the reproduction signal is prevented from dropping.

FIG. 3B shows a state in which the first recording layer 103 of the optical disk 100 is selected and the beam is focused on the selected first recording layer 103 in the recording/reproducing apparatus. Additionally, in FIG. 3B, the light beam 210 passes through the outside of the outer peripheral portion of the read-in emboss-area 105 of the 0 recording layer 102 which is the innermost peripheral portion of the groove area 104-0 and is focused on the selected first recording layer 103. Therefore, the light beam 210 is transmitted through the outside of the boundary between the read-in emboss-area 105 and the groove area 104-0 to irradiate the first recording layer 103. As shown in FIG. 3B, when passing through the groove area 104-0 of the 0 recording layer 102, the light beam 210 undergoes a refraction in the groove, but the formation of the beam spot in the groove area 104-1 of the first recording layer 103 is not influenced. The reflected light beam from the beam spot on the groove area 104-1 of the first recording layer 103 is passed through the groove area 104-0 of the first recording layer 103. However, since the area has substantially uniform physical characteristics, the reliability of the reproduction signal does not drop.

In the optical system shown in FIG. 3A, when the light beam is passed through the outer peripheral edge of the read-in emboss-area 105 and the groove area 104-0 of the 0 recording layer 102 and focused in the first recording layer 103, the light beam directed to the first recording layer 103 is modulated in the read-in emboss-area 105 and focused in the first recording layer 103. Because the read-in emboss-area 105 is different from the groove area 104-0 in physical characteristics. The reflected beam reflected from the beam spot on the groove area 104-1 is similarly passed through the outer peripheral edge of the read-in emboss-area 105 and the groove area 104-0 of the 0 recording layer 102 and directed to the detector 205. The reflected light beam is modulated in the read-in emboss-area 105 and directed to the detector 205, because the read-in emboss-area 105 is different from the groove area 104-0 in the physical characteristics. The reflected light beam detected by the detector 205 includes noise components involved in the modulation in the read-in emboss-area 105, and therefore the reliability of the reproduction signal sometimes drops.

When the light beam is passed through the read-in emboss-area 105 of the 0 recording layer 102 and focused in the first recording layer 103, the reliability of the reproduction signal sometimes drops, because the reflected light beam naturally directed to the detector 205 includes the noise component involved in the modulation in the read-in emboss-area 105.

To solve the problem, as described above, all the areas where the light beam passed through the read-in emboss-area 105 is focused on the first recording layer 103 are defined as the non-recording zones, and the groove area 104-1 excluding the non-recording zones is defined in the area where information or data can substantially be recorded in the first recording layer 103. When the areas are defined, and even when the reflected light beam directed to the detector 205 contains the noise components involved in the modulation in the read-in emboss-area 105, the detection signal from the detector 205 is prevented from being handled as the reproduction signal.

For the boundary of the recordable zone on the first recording layer 103, as described with reference to FIG. 3B, a range in which the light beam focused on the first recording layer 103 passes through the groove area 104-0 outside the outer peripheral edge of the read-in emboss-area 105 to form the beam spot on the groove area 104-1 is defined as the limit. Concretely, the recordable zone on the first recording layer 103 is defined slightly outside a boundary radius of the read-in emboss-area 105 and groove area 104-0 in the 0 recording layer 102. A distance from the boundary may also be defined by estimation of a sum of a spot radius on the 0 recording layer 102 in the focused state in the first recording layer 103, and allowable eccentricity between the layers. It is to be noted that valid information is presumed not to be recorded in the non-recording zone, but the area is not inhibited from being used as the recording zone of invalid information for purposes of test recording, synchronous pattern, or buffering effect.

It is to be noted that FIG. 3C shows that the noise is mixed in the reproduction light beam in searching the inner peripheral portion of the read-in emboss-area 105 of the 0 recording layer 102 with the light beam. When the beam spot is formed in the inner peripheral end of the read-in emboss-area 105 by the focused light beam, the light beam is passed through the 0 recording layer 102 including the beam spot formed and directed toward the first recording layer 103. The light beam from the beam spot forms a beam pattern on the first recording layer 103. However, the groove areas 104 are continuously disposed in the area in which the pattern is formed, and then the physical characteristics in the area are substantially uniform. Therefore, as described above, the influence of the groove is small, and the reliability of the reproduction signal does not drop. However, a terminal end of the groove area 104 is disposed in the area where the pattern is formed. When the groove is discontinued in the area, the groove area exists, for example, together with a mirror surface area in a mixed manner in the beam pattern on the first recording layer 103, and the physical characteristics differ. Therefore, the reflected light beam from the read-in emboss-area 105 of the 0 recording layer 102 contains the noise component caused by the difference of the physical characteristics, and the reliability of the reproduction signal sometimes drops.

Therefore, in an area 340 of the read-in emboss-area 105 influenced by the first recording layer 103, the pit array of invalid information is preferably disposed. The pit array which is valid as read-in information is preferably disposed outside the area. In the area of the 0 recording layer 102 influenced by the first recording layer 103, the pit array is not disposed, the area is not defined in the area of the read-in emboss-area 105, and the groove area 104-1 of the first recording layer 103 may extend in the inner periphery of the pit array area of the 0 recording layer 102.

As described above, the optical disk includes a structure in which two layers are formed in one surface. The read-in emboss is not disposed in both the layers, and is disposed only in one layer, so that mutual influence of the layers is inhibited and the reliability of reproduction can be improved.

FIG. 4 shows the multi-layered optical disk according to a second embodiment of the present invention. As shown in FIG. 4, two layers of the recordable recording layers 102, 103 are laminated in the transparent substrate 101. Since the substantial structure of this optical disk is similar to that of the optical disk 100 shown in FIG. 1, the same components are denoted with the same reference numerals, and the description is omitted. For the optical disk 100 shown in FIG. 4, different from the optical disk 100 shown in FIG. 1, the read-in emboss-area 105 is not disposed in the 0 recording layer 102, and the groove area 104-0 is defined to the innermost periphery of the layer. On the other hand, the read-in emboss-area 105 is disposed in the inner periphery of the first recording layer 103, and the groove area 104-1 is defined in the outer periphery. Here, for the recordable zone on the 0 recording layer 102, the area where the focused light beam is passed through the 0 recording layer 102 when directing the light beam focused in the first recording layer 103 toward the groove area outside the outer peripheral end of the read-in emboss-area 105 is defined as the limit. Even in this structure, an effect similar to that of the first embodiment can be obtained.

It is to be noted that even in the optical disk including three or more stacked layers, the read-in emboss is disposed in any of the layers, and accordingly the optical disk of the present invention can be realized in the same manner as in the above-described embodiments. That is, with respect to one recording layer including the read-in emboss, all the above-described conditions concerning the other recording layers are satisfied. Accordingly, even in the optical disk including the multi-layered structure of two or more layers, information or data can exactly be reproduced without being influenced by the read-in emboss, and information or data of the read-in emboss can exactly be reproduced.

Moreover, in the description of the embodiments of the present invention, the case in which the read-in emboss is disposed in the innermost periphery in the same manner as in DVD-RAM has been described, but the present invention is not limited to this, and can obviously similarly be applied to a case in which the read-in emboss is disposed in the outermost periphery.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A multi-layered optical disk to which information is recorded with a focused light beam, comprising:
a transparent substrate;
a first recording layer and a second recording layers faced to each other and supported by the transparent substrate, the first recording layer having a non-erasable information zone on which a pit array is formed as non-erasable information and a first recordable zone on which a recording mark array is formed with an irradiation of the focused light beam passing through the transparent substrate, the second recording layer having a non-recording zone on which information data is prevented from being recoded and a second recordable zone on which a recording mark array is formed with the irradiation of the focused light beam, and the non-recording zone being faced to the non-erasable information zone and including an illumination region on which a beam spot is formed by the light beam focused on the non-erasable information zone.

2. The multi-layered optical disk according to claim 1, wherein a range of the second recordable zone is defined based on the beam spot formed on the second recording layer by the light beam which is focused on the outside of an outer peripheral edge of the non-erasable information zone in the first recording layer.

3. The multi-layered optical disk according to claim 1, wherein the outer peripheral edge is determined based on estimating a sum of a radius of a beam spot formed by the focusing light beam on the second recording layer and allowable eccentricity between the first recording layer and second recording layer.

4. The multi-layered optical disk according to claim 1, wherein a guide groove is formed in the first recordable zone, the second recordable zones and the non-erasable information zone.

5. The multi-layered optical disk according to claim 1, wherein the non-recording zone on the second recording layer is larger than the non-erasable information zone of the first recording layer.

6. The multi-layered optical disk according to claim 1, wherein the non-recording zone on the second recording layer is used as a recording zone of invalid information.

7. The multi-layered optical disk according to claim 6, wherein the invalid information includes at least one of test recording, synchronous pattern, and buffering effect.

8. The multi-layered optical disk according to claim 1, wherein the first recording layer is disposed at the incidence side of the focused light beam and the light beam passing through the first recording layer is incident on the second recording layer.

9. The multi-layered optical disk according to claim 1, wherein information on the non-erasable information zone includes an address for specifying the non-recording zone on the second recording layer.

10. The multi-layered optical disk according to claim 1, wherein the second recording layer is disposed at the incidence side of the focused light beam and the light beam passing through the second recording layer is incident on the first recording layer.

11. The multi-layered optical disk according to claim 1, wherein the non-erasable information zone is disposed in a lead-in area or a lead-out area of the optical disk.

12. A recording/reproducing apparatus for reproducing information from and recording information on a multi-layered optical disk comprising:
a light beam unit configured to generate a focused light beam on the optical disk, optical disk including
a transparent substrate;
a first recording layer and a second recording layers faced to each other and supported by the transparent substrate, the first recording layer having a non-erasable information zone on which a pit array is formed as non-erasable information and a first recordable zone on which a recording mark array is formed with the irradiation of the focused light beam passing through the transparent substrate, the second recording layer having a non-recording zone on which information data is prevented from being recoded and a second recordable zone on which a recording mark array is formed with the irradiation of the focused light beam, the non-recording zone being faced to the non-erasable information zone and including an illumination region on which a beam spot is formed by the light beam focused on the non-erasable information zone, and the non-erasable information zone includes address information for specifying the non-recording zone on the second recording layer; and
control unit configured to control reading of information on the non-erasable information zone and recording of data on the first and second recording layer to prevent information data from being recorded on the non-recording zone based on the address information.
